(19) United States
(12) Patent Application Publication
(10) Pub. No.: US 2019/0266503 A1
(43) Pub. Date: Aug. 29, 2019

(54) PARAMETER OPTIMIZATION APPARATUS, PARAMETER OPTIMIZATION METHOD, AND COMPUTER READABLE RECORDING MEDIUM

(71) Applicant: NEC CORPORATION, Tokyo (JP)

(72) Inventors: Takashi ONISHI, Tokyo (JP); Satoshi MORINAGA, Tokyo (JP); Yotaro WATANABE, Tokyo (JP)

(73) Assignee: NEC CORPORATION, Tokyo (JP)

(21) Appl. No.: 16/347,734

(22) PCT Filed: Oct. 11, 2017
(86) PCT No.: PCT/JP2017/036818

§ 371 Date: May 6, 2019

(30) Foreign Application Priority Data
Nov. 7, 2016 (JP) 2016-217597

(51) Int. Cl. G06N 5/04; G06N 7/00; G06F 17/50

(52) U.S. Cl. CPC G06N 5/04; G06F 17/5009; G06N 7/005

(57) ABSTRACT

A parameter optimization apparatus 10 includes a simulator 11, which executes a simulation on a specific event by using a parameter as an input, a data interpreter 2, which converts the result of the output from the simulator 11 into a logical expression, an inference unit 13, which estimates a phenomenon that occurs in the specific event by using the logical expression, a query representing a target state of the specific event, and knowledge information prepared in advance for the specific event and generates an inference path from the estimated phenomenon, and a parameter determiner 14, which determines from the inference path a new parameter that is an input in the simulation, and when the new parameter is determined, the simulator 11 executes the simulation on the specific event by using the new parameter as an input.

### TECHNICAL FIELD

The present invention relates to a parameter optimization apparatus and a parameter optimization method for optimizing a parameter when a simulation on a specific event is executed, and further to a computer readable recording medium on which a program for achieving the parameter optimization apparatus and the parameter optimization method is recorded.

### BACKGROUND ART

In recent years, a simulation, particularly, a computer simulation using a computer is used in a variety of fields. A computer simulation (hereinafter simply referred to as “simulation”) is executed by a computer that constructs a model that simulates a system under the simulation and inputs a variety of parameters to the model.

For example, to simulate cultivation of an agricultural product in a farm, the following parameters are input to a computer that functions as a simulator: precipitation; irradiation; soils; terrain; fertilizer, farm working; and other factors. The computer then predicts the yield of the agricultural product in accordance with the values of the input parameters and outputs the predicted value. The thus executed simulation therefore allows a producer to grasp in advance how to culture the agricultural product in such a way that the yield thereof increases.

To execute a simulation, it is necessary to input a plurality of parameters as described above, and to produce a satisfactory simulation result, it is necessary to find an appropriate parameter combination. As an approach for finding an appropriate parameter combination, a grid search and Bayesian optimization have been known (see Non-Patent Document 1, for example).

In the grid search, parameter search spaces separate from one another in the form of a grid are set by using the number of parameters under the search as the dimension of the search. At this point, a parameter combination is assigned on a grid point basis, and a simulation is executed on a grid point basis.

It is, however, necessary in the grid search to execute a simulation for every parameter combination. The grid search is therefore inappropriate in a case where a large cost per simulation is incurred.

In contrast, in Bayesian optimization, a parameter combination candidate is first selected based on existing information, and a simulation is executed by using the selected parameter combination. Another parameter combination is then selected based on the result of the executed simulation, and another simulation is executed. That is, according to Bayesian optimization, since the simulation is executed by guessing parameters that are likely to be appropriate, the number of simulations can be reduced as compared with the number in the grid search, and the simulation cost can therefore be lowered.

### LIST OF RELATED ART DOCUMENTS

### Non Patent Document

Non-Patent Document 1: Koji Makiyama, anonymous intellectual organization HOXO-M Inc., “Introduction to Bayesian optimization for machine learning,” [online], Aug. 25, 2016, Manatee, [Searched on Oct. 11, 2016], Internet <URL: https://book.mynavi.jp/manatee/detail/id=59393>

### SUMMARY OF INVENTION

### Problems to be Solved by the Invention

In Bayesian optimization, it is believed in the selection of a parameter combination that use of knowledge on an event under the simulation allows more efficient selection of a parameter combination. For example, in the simulation of cultivation of an agricultural product described above, it is believed that use of knowledge on agriculture allows selection of a more probable parameter combination.

In Bayesian optimization of related art, however, use of knowledge has not been considered, and a parameter combination is selected by setting an evaluation function in place of an objective function. Therefore, the reduction in the number of simulations is limited to a certain number even by using Bayesian optimization. As a result, the reduction in the simulation cost is limited to a certain cost.

An object of the present invention is, for example, to solve the problems described above and provide a parameter optimization apparatus, a parameter optimization method, and a computer readable recording medium that allow efficient selection of an optimum parameter combination in a simulation executed on a specific event.

### Means for Solving the Problems

To achieve the object described above, a parameter optimization apparatus in an aspect of the present invention includes

a simulator that executes a simulation on a specific event by using a parameter as an input,

a data interpreter that converts a result of an output from the simulator into a logical expression,

an inference unit that estimates a phenomenon that occurs in the specific event by using the logical expression, a query representing a target state of the specific event, and knowledge information prepared in advance for the specific event and generates an inference path from the estimated phenomenon, and

a parameter determiner that determines from the inference path a new parameter that is an input in the simulation, and

when the new parameter is determined, the simulator executes the simulation on the specific event again by using the new parameter as an input.

To achieve the object described above, a parameter optimization method in another aspect of the present invention includes the steps of

(a) executing a simulation on a specific event by using a parameter as an input,

(b) converting a result of an output from the simulator into a logical expression,

(c) estimating a phenomenon that occurs in the specific event by using the logical expression, a query representing a target state of the specific event, and knowledge information prepared in advance for the specific event and generating an inference path from the estimated phenomenon, and

(d) determining from the inference path a new parameter that is an input in the simulation, and

when the new parameter is determined, the simulation on the specific event is executed again by using the new parameter as an input in the step (a).

Further, to achieve the object described above, a computer readable recording medium in another aspect of the present invention includes a program recorded thereon, the program including instructions that causes a computer to carry out the steps of

(a) executing a simulation on a specific event by using a parameter as an input,

(b) converting a result of an output from the simulator into a logical expression,

(c) estimating a phenomenon that occurs in the specific event by using the logical expression, a query representing a target state of the specific event, and knowledge information prepared in advance for the specific event and generating an inference path from the estimated phenomenon, and

(d) determining from the inference path a new parameter that is an input in the simulation, and

when the new parameter is determined, the program causes the computer to execute the simulation on the specific event again by using the new parameter as an input in the step (a).

### Advantageous Effects of the Invention

As described above, according to the present invention, an optimum parameter combination can be efficiently selected in a simulation executed on a specific event.

### BRIEF DESCRIPTION OF THE DRAWINGS

FIG. 1 is a block diagram showing a schematic configuration of a parameter optimization apparatus in an embodiment of the present invention.

FIG. 2 is a block diagram showing a specific configuration of the parameter optimization apparatus in the embodiment of the present invention.

FIG. 3 shows an example of data used in the embodiment of the present invention.

FIG. 4 is a flowchart showing the action of the parameter optimization apparatus in the embodiment of the present invention.

FIG. 5 is a block diagram showing an example of a computer that achieves the parameter optimization apparatus in the embodiment of the present invention.

### EXAMPLE EMBODIMENT

### Embodiment

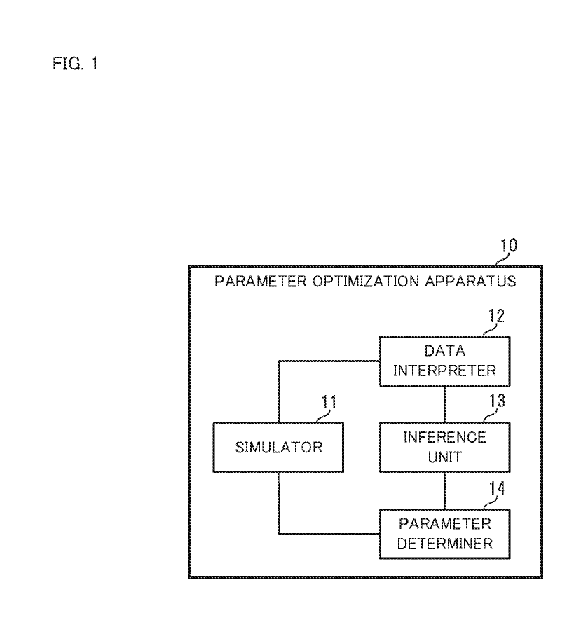

A parameter optimization apparatus, a parameter optimization method, and a program in an embodiment of the present invention will be described below with reference to FIGS. 1 to 5.

[Configuration of Apparatus]

A schematic configuration of the parameter optimization apparatus in the present embodiment will first be described. FIG. 1 is a block diagram showing a schematic configuration of a parameter optimization apparatus in an embodiment of the present invention.

A parameter optimization apparatus 10 in the present embodiment shown in FIG. 1 is an apparatus that optimizes parameters used in a simulation executed on a specific event. The parameter optimization apparatus 10 includes a simulator 11, a data interpreter 12, an inference unit 13, and a parameter determiner 14, as shown in FIG. 1.

The simulator 11 executes a simulation on a specific event by using a parameter as an input. The data interpreter 12 converts the result of the output from the simulator 11 into a logical expression.

The inference unit 13 uses the logical expression, a query representing a target state of the specific event, and knowledge information prepared in advance for the specific event to estimate a phenomenon that occurs in the specific event. The inference unit 13 further generates an inference path from the estimated phenomenon.

The parameter determiner 14 determines from the inference path a new parameter that is an input in the simulation. When a new parameter is determined, the simulator 11 uses the new parameter as an input to execute the simulation on the specific event again.

As described above, in the present embodiment, when the simulator 11 executes a simulation, knowledge information is applied to the result of the simulation to estimate a phenomenon, and further, a new parameter is determined from the result of the estimation. A simulation using the new parameter is then executed again. That is, in the present embodiment, since a simulation can be executed in consideration of prior knowledge on a specific event, an optimum parameter combination can be efficiently selected when a simulation on the specific event is executed.

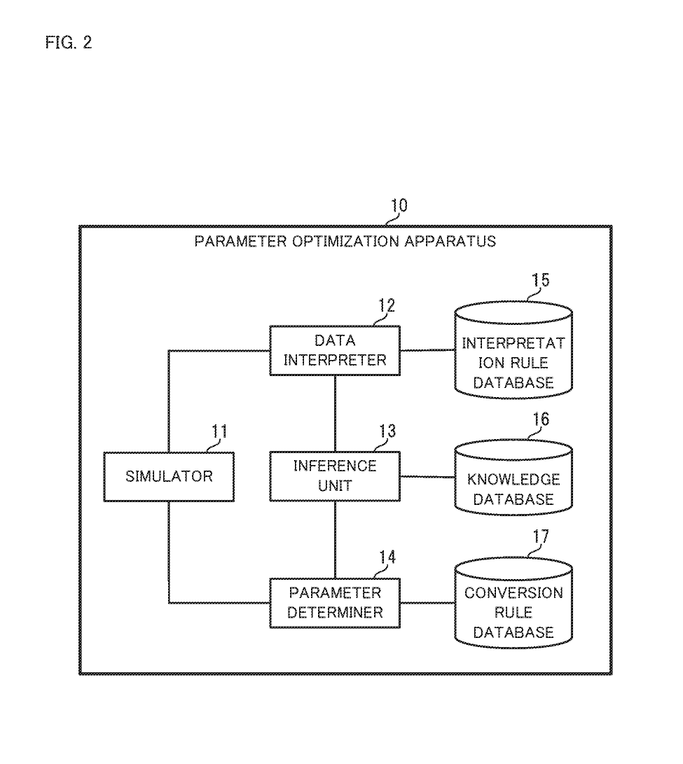

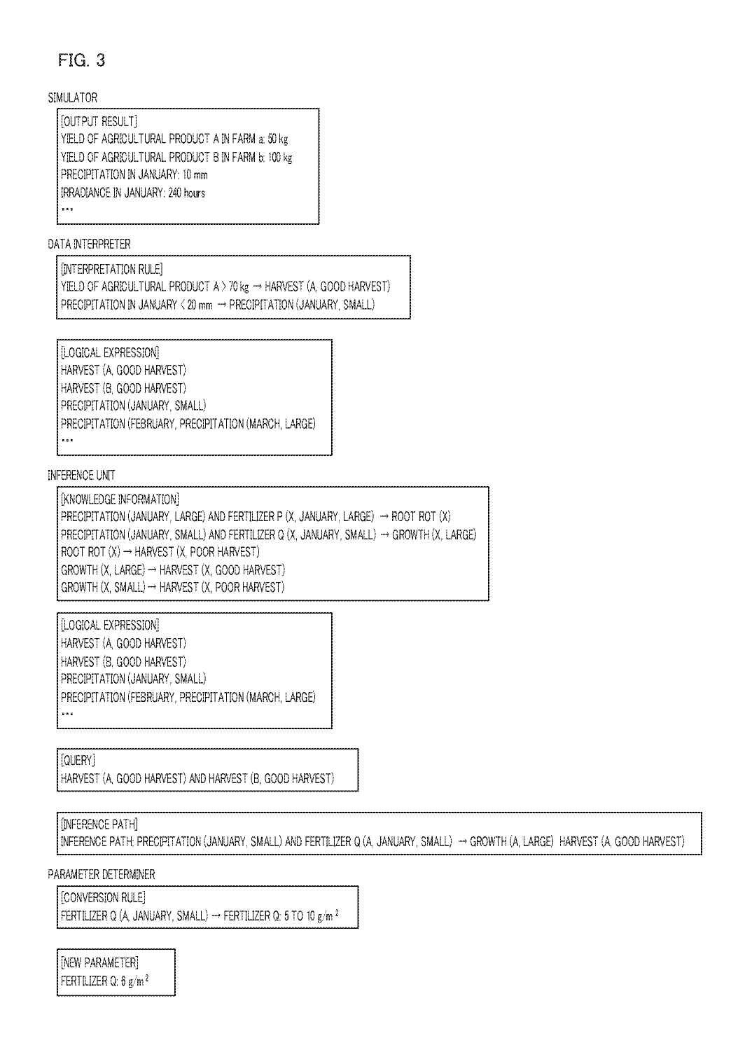

The configuration of the parameter optimization apparatus 10 in the present embodiment will subsequently be more specifically described with reference to FIGS. 2 and 3. FIG. 2 is a block diagram showing a specific configuration of the parameter optimization apparatus in the embodiment of the present invention. FIG. 3 shows an example of data used in the embodiment of the present invention.

In the present embodiment, the parameter optimization apparatus 10 includes an interpretation rule database 15, a knowledge database 16, and a conversion rule database 17 in addition to the simulator 11, the data interpreter 12, the inference unit 13, and the parameter determiner 14, as shown in FIG. 2. Information stored in each of the databases will be described later.

In the present embodiment, the simulator 11 has a model that simulatively recreates a specific event and recreates the specific event when a parameter is input to the model. Examples of the specific event may include production of an agricultural product in a farm, operation of a plant, and flight of an airplane. Therefore, in the case where the specific event is production of an agricultural product, the simulator 11, when it accepts as a parameter, for example, the planting area over which the agricultural product is produced, the amount of fertilizer, the timing at which the fertilizer is given, and other factors, calculates the yield of the agricultural product in accordance with the accepted parameters (see FIG. 3).

In the present embodiment, the data interpreter 12 converts the result of the output from the simulator 11, for example, numerical data, category data, or any other data into a logical expression based on an interpretation rule set in advance. The interpretation rule is stored in the interpretation rule database 15. The logical expression may, for example, be first order predicate logic (FOL). The input data input to the data interpreter 12 is not limited to the result of the output from the simulator 11 and may be a parameter input to the simulator 11.

Specifically, assume that the result of the output from the simulator 11 is, for example, “The yield of an agricultural product A in a farm a: 50 kg, the yield of an agricultural product B in a farm b: 100 kg, the precipitation in January: 10 mm, the irradiance in January: 240 hours, and so on,” as shown in FIG. 3. Further, assume that the interpretation rule database 15 stores an interpretation rule stating “The yield of the agricultural product A>70 kg→harvest (A, good harvest)” and “the precipitation in January<20 mm→the precipitation (January, small),” as shown in FIG. 3.

In this case, the data interpreter 12 applies the output result to the interpretation rule to create a logical expression stating “Harvest (A, good harvest), Harvest (B, good harvest), precipitation (January, small), precipitation (February, average), precipitation (March, large), and so on,” as shown in FIG. 3.

As the knowledge information in the present embodiment, the inference unit 13 uses knowledge information stored in the knowledge database 16. In a case where the specific event is production of an agricultural product in a farm, the knowledge information may, for example, be information representing “In a case where a large amount of fertilizer P is given to the agricultural product A in January although a large amount of rain has fallen in January, the root of the agricultural product A rots [The amount of rain (January, large) AND the amount of fertilizer P (X, January, large)→root rot (X)]” (see FIG. 3).

In the present embodiment, the knowledge information may be manually created in advance or may be automatically or semi-automatically created, for example, from a textbook, a manual, or a past daily work report. In FIG. 3, “X” is an arbitrary parameter, and the content identified by X is not limited to a specific content.

The logical expression used by the inference unit 13 is, for example, the first order predicate logic described above. The query used by the inference unit 13 is, for example, a query representing “the harvest of each of the agricultural products A and B is a good harvest [Harvest (A, good harvest) AND harvest (B, good harvest)] shown in FIG. 3.

Assume that the query and the logical expression “Harvest (A, good harvest), harvest (B, good harvest), precipitation (January, small), precipitation (February, average), precipitation (March, large), and so on” shown in FIG. 3 are input, and the inference unit 13 generates the following inference path (see FIG. 3) based on the knowledge information described above.

Inference path: Precipitation (January, small) AND fertilizer Q (A, January, small)→growth (A, large)→harvest (A, good harvest)

In the present embodiment, the inference unit 13 has an estimation processing engine. The estimation processing engine, when the logical expression, the query, and the knowledge information are input thereto, generates a logical path. The estimation processing engine may, for example, be a program created by a logical programming language called Prolog (PROgram in LOGic) (see Reference 1). Other examples of the inference processing engine may include a program created based on probabilistic logical inference (Reference 2) and a program created based on weighted abduction (Reference 3).
Reference 1: Katsumi Nitta, “Knowledge and Reasoning,” SAIENSU-SHA Co., Ltd., pp. 58 to 62
Reference 2: JSAI2016, Kentarou Sasaki, Daniel Andrade, Yotaro Watanabe, and Kunihiko Sadamasa, “Identification of rule set that plainly describes inference result of probabilistic logical inference,” The 30^{th} Annual Conference of the Japanese Society for Artificial Intelligence 2016
Reference 3: Kazeto Yamamoto, Naoya Inoue, and Kentaro Inui, “Abductive inference engine for language processing,” Phillip, The Association for natural Language Processing, 21th annual meeting, March, 2015

In the present embodiment, the parameter determiner 14 uses the parameter in the already executed simulation and the output result thereof to execute Bayesian optimization to determine a parameter candidate. The parameter determiner 14 then corrects the parameter candidate based on the inference path to determine a new parameter.

Specifically, assume that the parameter determiner 14 has used the parameter in the already executed simulation and the output result thereof to execute Bayesian optimization to obtain, for example, “fertilizer Q: 3 to 6 g/m²” as a parameter candidate.

The parameter determiner 14 selects a controllable predicate from the inference path generated by the inference unit 13. For example, in the case of the specific example of the inference path described above, the parameter determiner 14 selects “fertilizer Q (A, January, small)” as the controllable predicate. The parameter determiner 14 then applies the selected predicate to a conversion rule stored in the conversion rule database 17 to acquire a conversion result. For example, in a case where the conversion rule is “fertilizer Q (A, January, small)→fertilizer Q: 5 to 10 g/m²,” as shown in FIG. 3, the parameter determiner 14 acquires “fertilizer Q: 5 to 10 g/m²,” as the conversion result.

In this case, the parameter determiner 14 then corrects the parameter candidates “fertilizer Q: 3 to 6 g/m²” by using the conversion result of “fertilizer Q: 5 to 10 g/m²” to determine the corrected parameter candidate as a new parameter. In the case described above, “fertilizer Q: 6 g/m²,” for example, is determined as the new parameter (see FIG. 3). The parameter determiner 14 then inputs the new parameter to the simulator 11.

[Action of Apparatus]

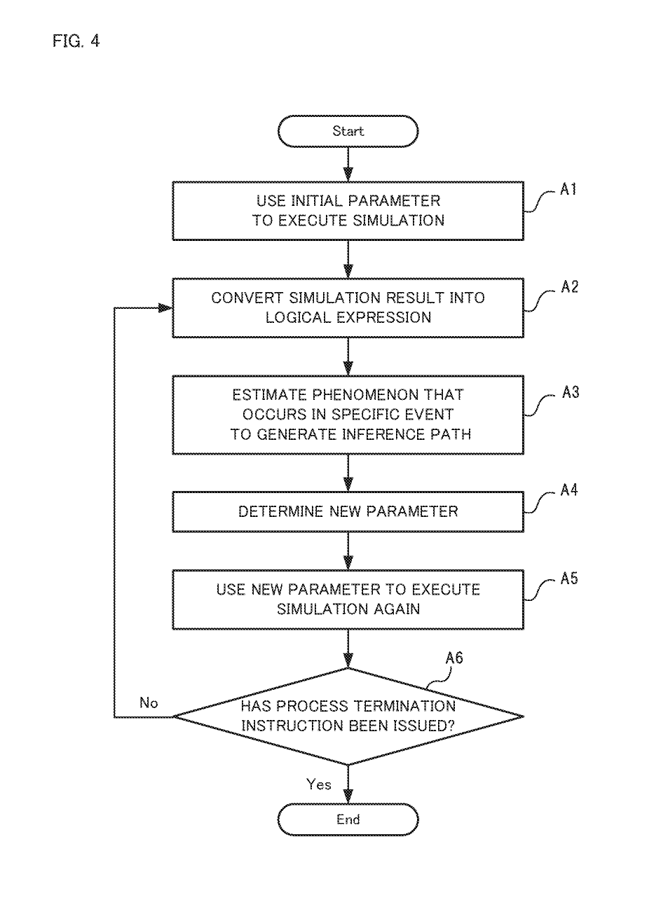

The action of the parameter optimization apparatus 10 in the present embodiment will next be described with reference to FIG. 4. FIG. 4 is a flowchart showing the action of the parameter optimization apparatus in the embodiment of the present invention. In the following description, FIGS. 1 to 3 are referred to as appropriate. In the present embodiment, a parameter optimization method is carried out by operating the parameter optimization apparatus 10. The action of the parameter optimization apparatus 10 will therefore be described below in lieu of the description of the parameter optimization method in the present embodiment.

The simulator 11 first executes a simulation on a specific event by using a parameter in an initial setting as an input (step A1), as shown in FIG. 4. The simulator 11 forwards the result of the simulation to the data interpreter 12.

The data interpreter 12 then converts the simulation result obtained in step A1 into a logical expression based on the interpretation rule stored in the interpretation rule database 15 (step A2). The data interpreter 12 forwards the resultant logical expression to the inference unit 13.

The inference unit 13 then uses the logical expression generated in step A2, the query representing a target state of the specific event, and the knowledge information stored in the knowledge database 16 to estimate a phenomenon that occurs in the specific event to generate an inference path from the estimated phenomenon (step A3). The inference unit 13 forwards the generated inference path to the parameter determiner 14.

The parameter determiner 14 then determines from the inference path generated in step A3 a new parameter that is an input in a simulation (step A4). The parameter determiner 14 forwards the determined new parameter to the simulator 11.

The simulator 11 then uses the new parameter determined in step A4 as an input to execute a simulation on the specific event again (step A5).

The simulator 11 then evaluates whether or not a process termination instruction has been issued (step A6). In a case where a result of the evaluation in step A6 shows that no process termination instruction has been issued, the simulator 11 forwards the result of the simulation to the data interpreter 12. Step A2 is thus carried out again. On the other hand, in a case where the process termination instruction has been issued, the simulator 11 outputs the result out of the parameter optimization apparatus 10.

As described above, according to the present embodiment, the steps of converting a simulation result into a logical expression, generating an inference path, determining a new parameter, and executing a simulation using the new parameter are repeatedly carried out. To generate an inference path, knowledge information is used. Therefore, according to the present embodiment, to execute a simulation on a specific event, an optimum parameter combination can be efficiently selected.

[Program]

A program in the present embodiment may be a program that causes a computer to carry out steps A1 to A6 shown in FIG. 4. The parameter optimization apparatus 10 and the parameter optimization method in the present embodiment can be achieved by installing the program in a computer and causing the computer to execute the program. In this case, a processor of the computer functions as the simulator 11, the data interpreter 12, the inference unit 13, and the parameter determiner 14 to carry out processing.

The program in the present embodiment may instead be executed by a computer system formed of a plurality of computers. In this case, for example, the computers may each function as any of the simulator 11, the data interpreter 12, the inference unit 13, and the parameter determiner 14.

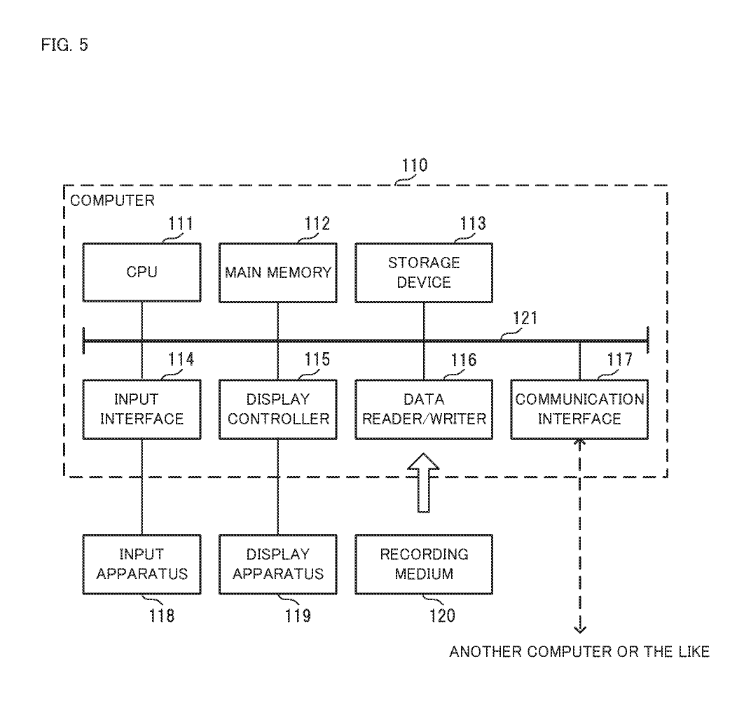

A description will now be made of a computer that executes the program in the present embodiment to achieve the parameter optimization apparatus 10 with reference to FIG. 5. FIG. 5 is a block diagram showing an example of a computer that achieves the parameter optimization apparatus in the embodiment of the present invention.

A computer 110 includes a CPU (Central Processing Unit) 111, a main memory 112, a storage device 113, an input interface 114, a display controller 115, a data reader/writer 116, and a communication interface 117, as shown in FIG. 5. The components described above are connected to each other via a bus 121 in a data communicable manner.

The CPU 111 develops the program (codes) in the present embodiment, which is stored in the storage device 113, in the main memory 112 and executes the codes in a predetermined order to perform a variety of computation. The main memory 112 is typically a volatile storage device, such as a DRAM (Dynamic Random Access Memory). The program in the present embodiment is provided as a program stored in a computer readable recording medium 120. The program in the present embodiment may instead be a program distributed over the Internet connected via the communication interface 117.

Specific examples of the storage device 113 may include a hard disk drive and a semiconductor storage device, such as a flash memory. The input interface 114 mediates data transmission between the CPU 111 and an input apparatus 118, such as a keyboard and a mouse. The display controller 115 is connected to a display apparatus 119 and controls the display on the display apparatus 119.

The data reader/writer 116 mediates data transmission between the CPU 111 and the recording medium 120, reads the program from the recording medium 120, and writes the result of the processing performed by the computer 110 onto the recording medium 120. The communication interface 117 mediates data transmission between the CPU 111 and another computer.

Specific examples of the recording medium 120 may include a CF (CompactFlash (registered trademark)), an SD (Secure Digital), and other general-purpose semiconductor storage devices, a flexible disk and other magnetic recording media, and a CD-ROM (Compact Disk Read Only Memory) and other optical recording media.

The parameter optimization apparatus 10 in the present embodiment may not be a computer in which the program is installed and may instead be achieved by using hardware corresponding to each portion of the parameter optimization apparatus 10. The parameter optimization apparatus 10 may still instead be so achieved that part of the parameter optimization apparatus 10 is achieved by a program and the remainder thereof is achieved by hardware.

Part or entirety of the embodiment described above can be expressed by (Supplementary note 1) to (Supplementary note 9) described below, but not limited thereto.

(Supplementary note 1) A parameter optimization apparatus including

a simulator that executes a simulation on a specific event by using a parameter as an input,

a data interpreter that converts a result of an output from the simulator into a logical expression,

an inference unit that estimates a phenomenon that occurs in the specific event by using the logical expression, a query representing a target state of the specific event, and knowledge information prepared in advance for the specific event and generates an inference path from the estimated phenomenon, and

a parameter determiner that determines from the inference path a new parameter that is an input in the simulation,

wherein when the new parameter is determined, the simulator executes the simulation on the specific event again by using the new parameter as an input.

(Supplementary note 2) The parameter optimization apparatus described in Supplementary note 1, in which the data interpreter converts the result of the output from the simulator into first order predicate logic based on a rule set in advance.

(Supplementary note 3) The parameter optimization apparatus described in Supplementary note 1 or 2, in which the parameter determiner performs Bayesian optimization by using the parameter in the already executed simulation and the output result thereof to determine a parameter candidate and further corrects the parameter candidate based on the inference path to determine the new parameter.

(Supplementary note 4) A parameter optimization method including the steps of

(a) executing a simulation on a specific event by using a parameter as an input,

(b) converting a result of an output from the simulator into a logical expression,

(c) estimating a phenomenon that occurs in the specific event by using the logical expression, a query representing a target state of the specific event, and knowledge information prepared in advance for the specific event and generating an inference path from the estimated phenomenon, and

(d) determining from the inference path a new parameter that is an input in the simulation,

wherein when the new parameter is determined, the simulation on the specific event is executed again by using the new parameter as an input in the step (a).

(Supplementary note 5) The parameter optimization method described in Supplementary note 4, in which the result of the output from the simulator is converted in the step (b) into first order predicate logic based on a rule set in advance.

(Supplementary note 6) The parameter optimization method described in Supplementary note 4 or 5, in which Bayesian optimization is performed in the step (d) by using the parameter in the already executed simulation and the output result thereof to determine a parameter candidate and further, the parameter candidate is corrected based on the inference path to determine the new parameter.

(Supplementary note 7) A computer readable recording medium that includes a program recorded thereon, the program including instructions that causes a computer to carry out the steps of

(a) executing a simulation on a specific event by using a parameter as an input,

(b) converting a result of an output from the simulator into a logical expression,

(c) estimating a phenomenon that occurs in the specific event by using the logical expression, a query representing a target state of the specific event, and knowledge information prepared in advance for the specific event and generating an inference path from the estimated phenomenon, and

(d) determining from the inference path a new parameter that is an input in the simulation,

wherein when the new parameter is determined, the program causes the computer to execute the simulation on the specific event again by using the new parameter as an input in the step (a).

(Supplementary note 8) The computer readable recording medium described in Supplementary note 7, in which the result of the output from the simulator is converted in the step (b) into first order predicate logic based on a rule set in advance.

(Supplementary note 9) The computer readable recording medium described in Supplementary note 7 or 8, in which Bayesian optimization is performed in the step (d) by using the parameter in the already executed simulation and the output result thereof to determine a parameter candidate and further, the parameter candidate is corrected based on the inference path to determine the new parameter.

The invention of the present application has been described above with reference to an embodiment, but the invention of the present application is not limited to the embodiment described above. A variety of changes comprehensible by a person skilled in the art can be made to the configuration and details of the invention of the present application within the scope thereof.

The present application claims the priority based on JP2016-217597A filed on Nov. 7, 2016, and the entirety of the disclosure thereof is incorporated herein.

### INDUSTRIAL APPLICABILITY

As described above, according to the present invention, an optimum parameter combination can be efficiently selected in a simulation executed on a specific event. The present invention is useful in a variety of fields in each of which a simulation is executed.

### REFERENCE SIGNS LIST

10 Parameter optimization apparatus
11 Simulator
12 Data interpreter
13 Inference unit
14 Parameter determiner
15 Interpretation rule database
16 Knowledge database
17 Conversion rule database
110 Computer
111 CPU
112 Main memory
113 Storage device
114 Input interface
115 Display controller
116 Data reader/writer
117 Communication interface
118 Input apparatus
119 Display apparatus
120 Recording medium
121 Bus

1. A parameter optimization apparatus comprising:
a simulator that executes a simulation on a specific event by using a parameter as an input;
a data interpreter that converts a result of an output from the simulator into a logical expression;
an inference unit that estimates a phenomenon that occurs in the specific event by using the logical expression, a query representing a target state of the specific event, and knowledge information prepared in advance for the specific event and generates an inference path from the estimated phenomenon; and
a parameter determiner that determines from the inference path a new parameter that is an input in the simulation,
wherein when the new parameter is determined, the simulator executes the simulation on the specific event again by using the new parameter as an input.

2. The parameter optimization apparatus according to claim 1,
wherein the data interpreter converts the result of the output from the simulator into first order predicate logic based on a rule set in advance.

3. The parameter optimization apparatus according to claim 1,
wherein the parameter determiner performs Bayesian optimization by using the parameter in the already executed simulation and the output result thereof to determine a parameter candidate and further corrects the parameter candidate based on the inference path to determine the new parameter.

4. A parameter optimization method comprising the steps of:
(a) executing a simulation on a specific event by using a parameter as an input;
(b) converting a result of the simulation into a logical expression;
(c) estimating a phenomenon that occurs in the specific event by using the logical expression, a query representing a target state of the specific event, and knowledge information prepared in advance for the specific event and generating an inference path from the estimated phenomenon; and
(d) determining from the inference path a new parameter that is an input in the simulation,
wherein when the new parameter is determined, the simulation on the specific event is executed again by using the new parameter as an input in the step (a).

5. The parameter optimization method according to claim 4,
wherein the result of the simulation is converted in the step (b) into first order predicate logic based on a rule set in advance.

6. The parameter optimization method according to claim 4,
wherein Bayesian optimization is performed in the step (d) by using the parameter in the already executed simulation and the output result thereof to determine a parameter candidate and further, the parameter candidate is corrected based on the inference path to determine the new parameter.

7. A non-transitory computer readable recording medium that includes a program recorded thereon, the program including instructions that causes a computer to carry out the steps of:
(a) executing a simulation on a specific event by using a parameter as an input;
(b) converting a result of the simulation into a logical expression;
(c) estimating a phenomenon that occurs in the specific event by using the logical expression, a query representing a target state of the specific event; and knowledge information prepared in advance for the specific event and generating an inference path from the estimated phenomenon, and
(d) determining from the inference path a new parameter that is an input in the simulation,
wherein when the new parameter is determined, the program causes the computer to execute the simulation on the specific event again by using the new parameter as an input in the step (a).

8. The non-transitory computer readable recording medium according to claim 7,
wherein the result of the simulation is converted in the step (b) into first order predicate logic based on a rule set in advance.

9. The non-transitory computer readable recording medium according to claim 7,
wherein Bayesian optimization is performed in the step (d) by using the parameter in the already executed simulation and the output result thereof to determine a parameter candidate and further, the parameter candidate is corrected based on the inference path to determine the new parameter.
